(19) United States
(12) Patent Application Publication
(10) Pub. No.: US 2007/0268288 A1
(43) Pub. Date: Nov. 22, 2007

(54) Method and Device for the Interactive Simulation of Contact Between Objects

(76) Inventors: Christian Duriez, Annoeullin (FR); Claude Andriot, Fontenay-Aux-Roses (FR)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/593,834

(22) PCT Filed: Mar. 23, 2005
(86) PCT No.: PCT/FR05/00699

§ 371 Date: Mar. 23, 2007

(30) Foreign Application Priority Data
Mar. 24, 2004 (FR) 0403037

(51) Int. Cl. G06T 17/00; G06T 15/00

(52) U.S. Cl. 345/420; 345/419

(57) ABSTRACT

The invention relates to a method of interactively simulating contact between objects. The inventive method comprises the following steps, namely: the parameters describing the physical characteristics of each of the objects are computed; at the beginning of each simulated model sampling time step, each object is subjected to a real-time analysis of the specific behavior thereof according to a free movement that does not take account of possible subsequent contacts, and, subsequently, at an overall scene level, pairs of detected intersecting objects are subjected to real-time analysis; a list of collision groups is established; for each collision group, parameters representing the physical characteristics of the objects and the description of the collisions are repatriated in real time, to characterize the contact between two objects in the case of a pure relative sliding movement; and, for each object, the specific behavior of the object following the collision is displayed in real time and the set of real-time processes is performed with a calculation time step shorter than the sampling time step.

The present invention relates to a method and a system for interactively simulating contact between a deformable object and a second object using a simulated model with a predetermined sampling time step.

It has already been proposed to simulate measurements of interpenetration between a rigid object and a deformable object from estimated volumes or distances, in particular for virtual surgery applications in which a virtual rigid surgical tool cooperates with a virtual deformable organ of the human body.

However, in the above methods the relationship between the interpenetration measurement and the reaction contact forces has no physical basis and artificial forces may be applied to nodes of the meshes of the objects that are not in contact, which compromises reliability since the contact forces do not comply with the conditions of the Signorini problem.

The present invention aims to eliminate the above-mentioned drawbacks and to provide interactive real-time simulation of contact between objects, at least some of which are deformable, in a simpler and economic manner, while simultaneously complying with the constraints of the laws of physics that govern such contact, so that the simulated contact between objects is reliable, and the stability of the simulation is therefore guaranteed.

The above objects are achieved by a method of interactively simulating contact between a deformable first object and a second object using a simulated model with a predetermined sampling time step, the method being characterized in that:

(a) the parameters describing the physical characteristics of each of the objects, such as the geometry and the mechanics of the materials of each of the objects, are calculated beforehand and stored in a memory,

(b) at the beginning of each sampling time step of the simulated model, a real-time analysis of the inherent behavior of each object is carried out at the level of each object in order to predict the positions, speeds and accelerations of that object in application of a free movement that does not take account of any subsequent contacts,

(c) in each sampling time step of the simulated model, pairs of objects that are detected as intersecting are analyzed in real time at the level of an overall scene including the objects liable to come into contact, and a list of groups of collisions is established that contains a string of objects in collision and a description of the collisions,

(d) in each sampling time step of the simulated model, parameters representing the physical characteristics of the objects and the description of the collisions are repatriated in real time for each group of collisions to determine, for each instance, the solution to the Signorini problem that governs contact between two objects in the case of pure relative sliding,

(e) at the end of each sampling time step of the simulated model, a real-time display of the inherent behavior of the object following the collision is effected at the level of each object, and

(f) all real-time processing is effected with a computation time step shorter than the sampling time step of the simulated model so as to define an interactive simulation in which the user can intervene directly during simulation.

During the step a) of calculating beforehand parameters describing the physical characteristics of each of the objects, a finite element type description of deformations is used for the parameters describing the mechanics of the materials, with matrices being filled and inverted systems of equations being solved, and data being stored in memory.

In one particular embodiment, each object is described in a rest configuration as a set of triangles reproducing its surface and a set of tetrahedra describing the interior of the object.

Each triangle is advantageously described by three points placed in an order such that normals are calculated that are invariably directed towards the exterior of the object.

The deformations of the objects are preferably interpolated by the finite element method using a linear tetrahedral mesh.

In each computation time step the explicit forces applied to an object, which are already known at the start of the computation step, are integrated during the step b) at object level to define the movements of the object that they generate, whereas the values of the implicit contact forces, which depend on the movement of the objects in the computation time step, are determined during the step d) of seeking the solution to the Signorini problem at the level of an overall scene.

During the step c) of analysis at the level of an overall scene, the existing intersections between the objects of the scene are detected geometrically in order to extract from pairs of elements of intersecting objects a length and a direction of interpenetration between the two elements of a pair of elements of objects.

In one implementation, during the step c) of analysis at the level of an overall scene, to extract from pairs of elements of intersecting objects a length and a direction of interpenetration between the two elements of a pair of elements of objects, an intermediate movement of the objects between the preceding computation step and the current computation step is also taken into account in order to compute a preferential direction of interference between the objects.

During the step d) of seeking the solution to the Signorini problem, the extreme points of application of the contact force between the two objects in collision are reconstructed if those extreme application points have not been determined during the preceding step.

In one particular implementation, during the step d) of seeking the solution to the Signorini problem, in the case of a segment-segment intersection of two triangular objects, the two points selected to constitute the extreme points of application of the contact force between the two objects in collision are situated at the intersection of each of the two segments with the plane formed by the face of the triangle in the intersection.

In another particular implementation, during the step d) of seeking the solution to the Signorini algorithm, in the case of a point-face intersection of two triangular objects, a first point selected to constitute an extreme point of application of the contact force between the two objects in collision is the point of the intersection whereas the second extreme point of application of the contact force between the two objects in collision is the projection of the first extreme point onto the face of the triangle in the intersection.

According to one particular aspect of the invention, barycentric coordinates are used to distribute the displacements and the forces of the points of application of the contact force between the extreme points of application of the contact force by effecting a linear interpolation for a finite element modeling process.

In particular, the distance δ of interpenetration between the two extreme points of application of the contact force in the case of a segment-segment contact between a first segment and a second segment of a second triangle may be calculated from the following equation:

$$δ = [ \begin{matrix}{a}_{i} & {b}_{i} & {c}_{i}\end{matrix} ] [ [ \begin{matrix}α & 1 - α\end{matrix} ] [ \begin{matrix}{W}_{1} \\ {W}_{2}\end{matrix} ] - [ \begin{matrix}β & 1 - β\end{matrix} ] [ \begin{matrix}{V}_{1} \\ {V}_{2}\end{matrix} ] ] \qquad ( 1 )$$

in which:
α and 1−α are the barycentric coordinates on the first segment,
β and 1−β are the barycentric coordinates on the second segment,
aᵢ bᵢ cᵢ are the coordinates of the interpenetration direction nᵢ,
W₁ and W₂ are the coordinates of the first segment,
V₁ and V₂ are the coordinates of the second segment.

The distance δ of interpenetration between the two extreme points of application of the contact force in the case of a point-plane contact between a point of a second triangle and a plane of a first triangle may be calculated from the following equation:

$$δ = [ \begin{matrix}{a}_{i} & {b}_{i} & {c}_{i}\end{matrix} ] [ [ \begin{matrix}α & β & y\end{matrix} ] [ \begin{matrix}{W}_{1} \\ {W}_{2} \\ {W}_{3}\end{matrix} ] - {V}_{1} ] \qquad ( 2 )$$

in which:
α, β and γ are the barycentric coordinates on the first triangle,
aᵢ bᵢ cᵢ are the coordinates of the interpenetration direction nᵢ,
W₁, W₂, W₃ are the coordinates of the first triangle,
V₁ represents the coordinates of the point of contact consisting of a vertex of the second triangle.

When the points of application of the contact forces between two objects in collision have been determined, during the step d) the mechanical characteristics of the objects are transferred into the defined contact space in which the whole of a group of m contacts with n objects is processed, where m and n are integers.

In particular, during the step d) the mass and inertia of an object are considered lumped together at its centre of mass and an instantaneous relationship between the contact forces f_{c} in the contact direction, the accelerations δ″_{c} caused by the constraints in the same direction, and the free accelerations δ″_{free} in the same direction known during the step c) at the level of an overall scene is established from the equation:
δ″_{c}=J_{c}M⁻¹J_{c}^{T}f_{c}+δ″_{free} (3)
in which:
J_{c} is an m*6n Jacobean matrix that transfers the instantaneous linear and angular movement into the contact space,
J_{c}^{T} is the transposed matrix of J_{c},
M is a block diagonal matrix corresponding to the mass and inertia of the n objects of the group of contacts.

During the step d), to transport the local mechanical characteristics, a relationship is established between:
the displacement difference (Uₖⁱ) of the points of the deformable mesh representing the object i at the time k, between the free deformation (Uⁱ_{k.free}) and the constrained deformation (Uⁱ_{k,c}), in other words U^{k}ⁱ=Uⁱ_{k,c}−Uⁱ_{k,free}
the free and constrained relative positions δ_{free} and δ_{c} of the objects in the contact space:
   δ=Σ_{I=1}ⁿN_{c}ⁱUₖⁱ+δ_{free} (4)
   where N_{c}ⁱ is a matrix for passing from the displacement space of the mesh to the displacement space of the contacts.

Similarly, a relationship is established between the forces in the contact space f_{c} and the forces in the deformation forces space Fₖ:
Fₖ=(N_{c}ⁱ)^{T}f_{c} (5)

In particular, during the step d) an instantaneous linear relationship characterizing contact deformations or displacements δ_{c} from the contact forces f_{c} and the free displacements δ″_{free} caused by free movements integrating only the forces known explicitly at the beginning of the computation time step is established from the following equation:
δ_{c}=[Σᵢ₌₁ⁿN_{c}ⁱA(Uₖ₋₁) (N_{c}ⁱ)^{T}]f_{c}+δ_{free} (6)
in which:
Nⁱ_{c} is a matrix for passing from the displacement space of the mesh to the displacement space of the contacts,
(Nⁱ_{c})^{T} is the transposed matrix of Nⁱ_{c},
A is a matrix defining the deformation of the object at the local level, such that if Uₖ represents the vector of the displacement in the local frame of reference of the object at the current time and Uₖ₋₁ represents the displacement vector in the local frame of reference of the object in the preceding calculation step, the instantaneous values whereof are known at the beginning of the current computation step, then:
   U_{K}=A(Uₖ₋₁)Fₖ+b(Uₖ₋₁) (7)
   where:
Fₖ is a vector representing the external forces applied to the object expressed in the local frame of reference, and
b is a vector that has a value in the displacement space and depends on the object deformation model.

In a more general case, during the step d) an instantaneous relationship characterizing the contact deformations or displacements δ_{c} from the contact forces f_{c} and the free displacements δ″_{free} caused by free movements integrating only the forces known explicitly at the beginning of the computation time step is established from the following equation:
δ_{c}=[θdt²J_{c}M⁻¹J_{c}^{T} +Σᵢ₌₁ⁿN_{c}A(ₖ₋₁) (N_{c}ⁱ)^{T}]f_{c}+δ_{free} (8)
in which:
J_{c} is an m*6n Jacobean matrix that transfers the instantaneous linear and angular movement into the contact space,
J_{c}^{T} is the transposed matrix of J_{c},
M is a block diagonal matrix corresponding to the mass and inertia of the n objects of the group of contacts,
θ is a constant depending on the time integration method,
Nⁱ_{c} is a matrix for passing from the displacement space of the mesh to the displacement space of the contacts,
(Nⁱ_{c})^{T} is the transposed matrix of Nⁱ_{c},
A is a matrix defining the deformation of the object at the local level such that if Uₖ represents the vector of the displacement in the local frame of reference of the object at the current time and Uₖ₋₁ represents the displacement vector in the local frame of reference of the object in the preceding calculation step the instantaneous values whereof are known at the beginning of the current computation step, then:
   U_{K}=A(Uₖ₋₁)Fₖ+b(Uₖ₋₁) (7)
   where:
Fₖ is a vector representing the external forces applied to the object expressed in the local frame of reference, and
b is a vector that has a value in the displacement space and depends on the object deformation model.

The method according to the invention advantageously further comprises a step of coupling with a haptic interface module to produce haptic sensation feedback to a mechanical system by means of which an operator manipulates the objects in a virtual scene.

The invention also provides a system for interactively simulating contact between a deformable first object and a second object using a simulated model with a predetermined sampling time step, the system being characterized in that it comprises:

(a) a module for calculating beforehand parameters describing the physical characteristics of each of the objects, such as the geometry and the mechanics of the materials of each of the objects,

(b) a memory for storing parameters previously calculated in the computation module,

(c) a coupling module to a user interface comprising a mechanical system held by a user to exert virtual forces on said objects in a scene of the simulated model,

(d) a display screen for displaying said objects represented in the form of meshes,

(e) a central processor unit associated with input means, comprising at least:
e1) an object analysis module for analyzing in real time at the level of each object the inherent behavior of the object in order to predict the positions, speeds and accelerations of that object in application of a free movement that does not take account of any subsequent contacts,
e2) an analysis module for an overall scene including the objects liable to come into contact, for analyzing in real time pairs of objects that are detected to be interacting and to establish a list of groups of collisions that contains a string of objects in collision and a description of the collisions,
e3) a module for the real time repatriation, for each group of collisions, of the parameters representing the physical characteristics of the objects and the description of the collisions, for determining, for each instance, the solution to the Signorini problem that governs contact between two objects in the case of pure relative sliding,
e4) a module for processing each object for real time display at the level of each object of the inherent behavior of that object following a collision, and
e5) means for determining a computation step shorter than the sampling time step of the simulated model so as to define an interactive simulation.

The system advantageously comprises means for producing haptic sensation feedback to the user interface.

According to one advantageous feature, the computation step corresponds to a frequency greater than or equal to approximately 500 Hz.

Other features and advantages of the invention emerge from the following description of particular embodiments of the invention provided by way of example, which description is given with reference to the appended drawings, in which:

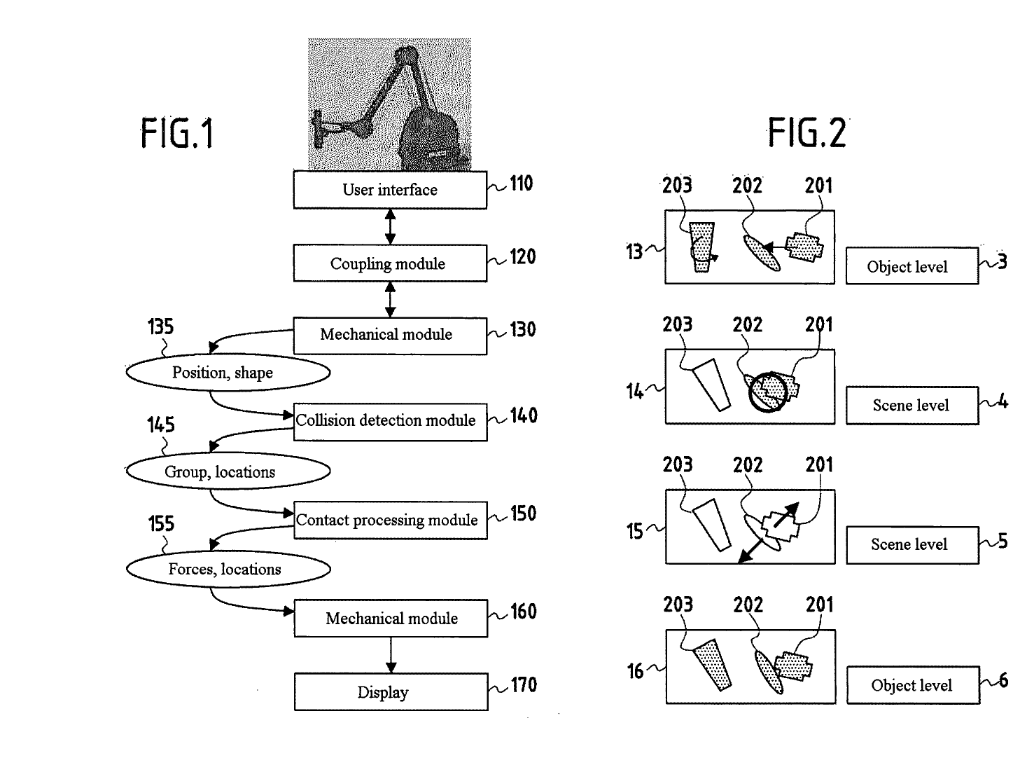

FIG. 1 is a diagram showing the steps of a method of the invention for interactively simulating contact between objects,

FIG. 2 is a diagram showing different levels of processing of the interaction between objects during different steps of the FIG. 1 simulation method,

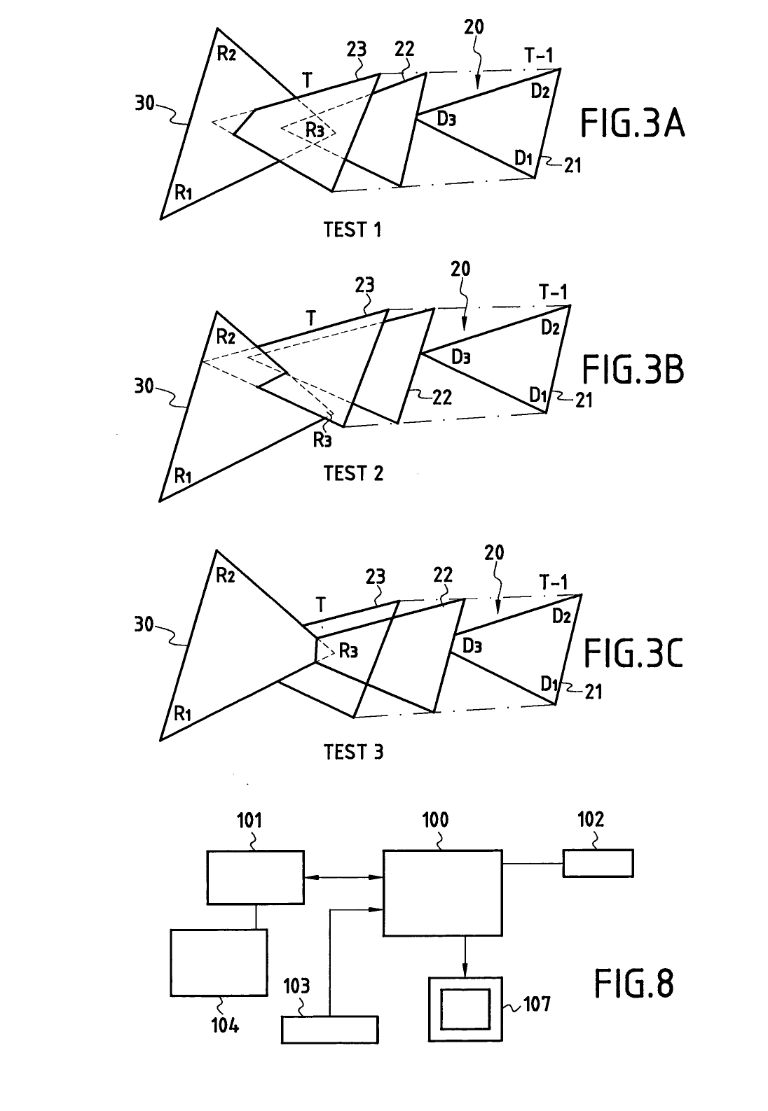

FIGS. 3A to 3C show three examples of interaction between two virtual objects represented by triangles,

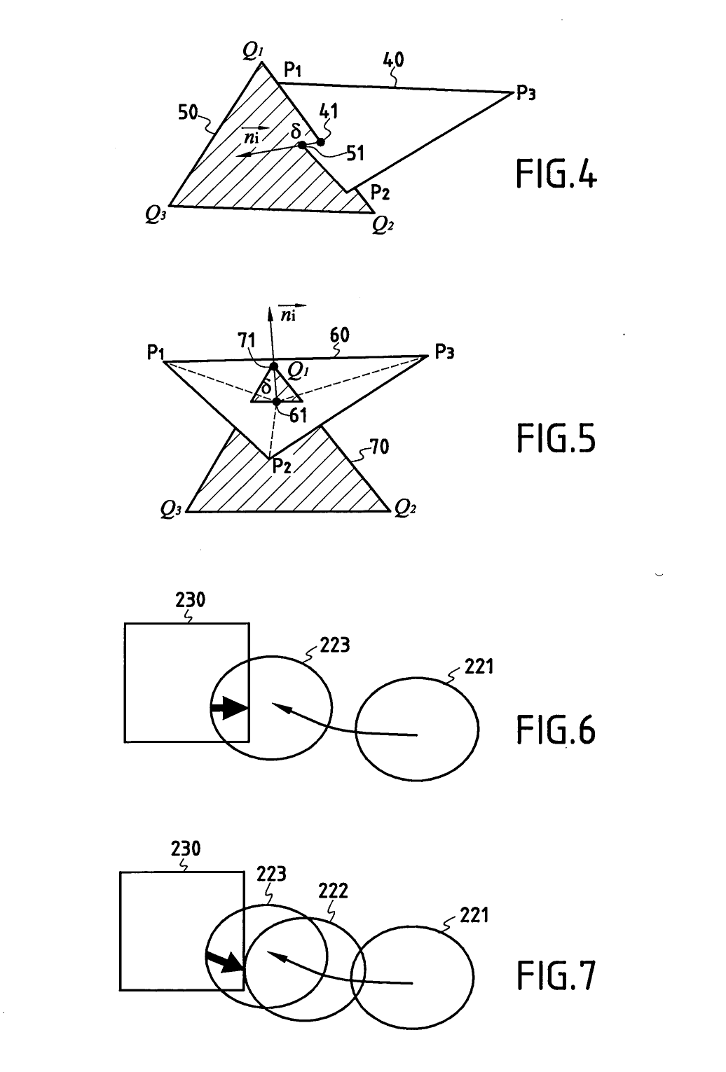

FIG. 4 represents an interaction between two triangular objects in the case of a segment-segment intersection,

FIG. 5 represents an interaction between two triangular objects in the case of a point-face intersection,

FIG. 6 is a diagram of a collision between two objects for which the configuration can be defined by geometrical criteria alone,

FIG. 7 is a diagram of a collision between two objects for which the configuration is defined taking account of an intermediate movement,

FIG. 8 is a block diagram showing the basic components of a system of the invention for interactively simulating contact between objects,

FIG. 9 shows one example of contact between a deformable virtual object and another virtual object, and

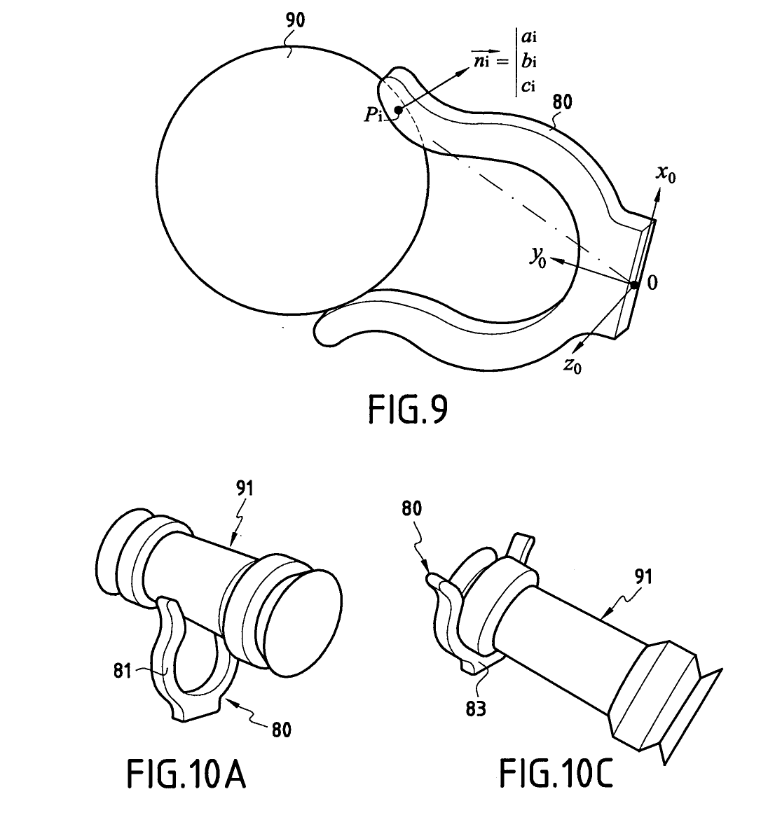

FIGS. 10A to 10C show three different relative positions of a deformable virtual object in the form of forceps and a rigid virtual object during a process of placement of the deformable virtual object in the form of forceps on the rigid virtual object.

FIG. 8 is a diagram showing one example of a system for implementing the invention and interactively simulating contact between objects in real time at the same time as providing haptic sensation feedback.

A simple processor unit 100, which may be based on a conventional computer, executes the various calculations necessary to perform a simulation.

A display screen 107 connected to the computer 100 via a graphic interface displays objects represented in the form of a mesh comprising nodes or vertices connecting segments or edges.

Information may be supplied to the computer 100 from a conventional user interface 103 that may comprise a keyboard and a mouse, for example, constituting input means.

A dedicated mechanical system 104 held by a user and connected via a coupling module 101 to the computer 100 may additionally be provided so that the user can exert virtual forces on the objects in a scene of a simulated model. A mechanical system 104 of this kind and the coupling module 101 constitute a haptic interface that enables the user to apply forces to the virtual objects in the scene and to receive in return a haptic simulation that is a response to the simulation of the contact between objects.

The computer 100 conventionally comprises a processor, a non-volatile memory for storing programs and data, and a working memory cooperating with the processor. External memory media (diskettes, CD-ROM, etc.) or a modem connected to a network may naturally be used to load into the computer programs or data for performing some or all of the simulation processing. In FIG. 8 there is merely shown in symbolic form a storage memory 102 that cooperates with the module 100 and may consist of one of the types of memory mentioned above.

Generally speaking, at the start of a simulation the parameters describing the geometry and the mechanics of the materials of the objects to be simulated are computed in the central unit 100 and stored in a memory area of the memory 102.

The processing performed by the central unit 100 uses a finite element type description of the mechanical deformations of the objects in order to characterize them. This processing entails filling and inverting matrices, solving systems of equations, and storing data in the memory 102 associated with the central unit 100.

The current shapes and positions of the objects are evaluated as a function of the applied loads and the mechanical laws that govern the objects in the scene.

To guarantee a stable simulation, the computation in accordance with the invention of the simulated contact between objects takes into account the laws of physics that govern such contact. To enable simulation in real time, i.e. with a very short and limited delay between a load applied by the user via the haptic interface 104, 101 and a response supplied to that haptic interface 104, 101 by the central processor unit 100, the simulation system uses three main modules that are called iteratively in each sampling time step of the simulated model. Moreover, all real time processing is effected with a calculation time step shorter than the sampling time step of the simulated model.

The three main modules of the simulation system implementing the various steps of the simulation method essentially take the following form:

A first or “mechanical” module, situated at the level of each object and describing its inherent behavior, causes the position and the shape of the object to evolve in accordance with the forces applied and the places at which they are applied. This module is called at the beginning of a calculation step to predict the positions, speeds and accelerations of the objects without taking account of the contact and is then called again to take account of the forces calculated in a third or “contact processing” module.

A second or “collision detection” module, situated at the level of the overall scene, establishes pairs of objects that are detected as intersecting. This module may optionally create intermediate movements between the simulation steps to determine when and how the objects came to intersect. This module is governed primarily by optimized geometrical laws that accelerate the computation in order to obtain a string of objects in collision and a description of the collisions. A collision group is a set of objects linked by one or more collisions. An object enters a group if it is in collision with at least one of the objects of the group. A collision is necessarily described by the pair of objects in collision and by the location of the collision using either intersecting basic geometrical elements (for example two triangles or two surfaces) or a straight line segment joining the two points that are locally interpenetrating the most.

A third or “contact processor” module is called by the “collision detection” module and in return calls the “mechanical” module. For each group of collisions, the contact processing module repatriates the physical characteristics of the objects and the description of the collisions. The module is adapted to determine, in each instance, the solution to the Signorini problem that governs the contact between two objects in the case of pure sliding.

The invention performs interactive simulation. A simulation is defined by the sampling time step of the simulated model and by its calculation time step. The method of the invention uses a calculation time step that is always less than the selected sampling time step, so producing an interactive simulation in which the user is able to intervene directly during the simulation.

FIG. 1 summarizes the main steps of the method of the invention, which employs a simulation loop using the three main modules cited above installed in the FIG. 8 computer 100. FIG. 2 shows the various levels of processing between objects during the various steps of the simulation method.

A first processing step 130 uses the “mechanical” module and is situated at the level of each object (object level 3). Information is supplied via a coupling module 120 from the user interface or haptic interface 110 that determines the position and the shape of each object (information 135 generated in the step 130).

In this first step 130, a modeling process 13 takes individual account of each object or tool 201, 202, 203 without taking account of any subsequent interactions and causes the position and the shape of the object to evolve in accordance with the forces applied from the user interface 110 and where they are applied.

A second processing step 140 uses the “collision detection” module and is situated at the level of an overall scene (scene level 4). The information 135 generated in the step 130 is used in the step 140 to establish pairs of objects that are detected as intersecting. During the step 130 a list of groups of collisions (information 145) is generated containing a string of objects in collision and a description of the collisions. In this step 140, a modeling process 14 therefore takes account of a pair of intersecting objects such as the objects 201, 202 at the level of an overall scene.

A third processing step 150 uses the “contact processing” module and is situated at the level of an overall scene (scene level 5). The information 145 generated in the step 140 and the information 135 generated in the step 130 are used to determine in each instance the solution to the Signorini problem that governs the contact between two objects in the case of pure sliding (information 155). In this step 150, a modeling process 15 therefore takes account of the interaction between two objects such as the objects 201, 202 at the level of an overall scene, the physical characteristics of the objects and the description of the collisions for each group of collisions being repatriated by the “contact processing” module.

The third processing step 150 supplies information 155 concerning forces and where they are applied that is sent to the first or “mechanical” module during a fourth processing step 160 that is also situated at the level of the objects (object level 6). In this step 160, the result of the real-time simulation processing may simply be normalized in a display step 170 or returned via the coupling module 120 to the user interface 110 to provide the user with haptic sensation feedback. In this final step, a modeling process 16 therefore takes individual account of each object or tool 201, 202, 203 as well as taking account of contacts previously simulated.

At the level of the object, in a preferred embodiment, the object is described as a set of triangles reproducing its surface and a set of tetrahedra for describing its interior, all within a rest configuration. This configuration corresponds to the shape of the object when no force is applied to it.

The triangles are advantageously described by three points, placed in an order such that the computation of the normals is invariably directed towards the exterior of the object. The surfaces of objects are closed so that an exterior can be distinguished from an interior.

The deformations of the objects are interpolated by the finite element method using a linear tetrahedral mesh. The system can simulate different behavior laws provided that an approximate linear relation between the forces exerted and the displacements around a local configuration can be extracted locally from it for a computation step.

If Uₖ represents the displacement vector of an object in the local frame of reference at a current time t and Uₖ₋₁ represents the displacement vector of the object in the local frame of reference in the preceding calculation step t−1, then:
Uₖ=A(Uₖ₋₁)Fₖ+b(Uₖ₋₁) (7)
where:
A is a matrix defining the deformation of the object at the local level,
Fₖ is a vector representing the external forces applied to the object expressed in the local frame of reference,
b is a vector that has a value in the displacement space and depends on the object deformation model, and
Uₖ₋₁ is a vector whose instantaneous values are known at the start of the calculation step of the current time t.

A distinction is advantageously made between the overall movement of the object described by the fundamental relationship of the dynamic and the deformation of the object around a current configuration described by the deformation law.

The forces applied to the object are distinguished by their explicit or implicit character. An explicit force is known at the beginning of the computation step and must be integrated to determine the movement of the object that it produces. Contact forces, on the other hand, are implicit in the sense that they depend on the movement of the objects in the time step. The explicit forces are therefore integrated for a time step before proceeding to the overall scene level to determine the value of the implicit forces.

After the explicit forces have been integrated at the level of each object, the configuration of the objects in the scene is called the “free” shape and position. This configuration is obtained without intervention of the contact forces. Thus a “free movement” is a movement integrating only the forces known explicitly at the beginning of the computation time step. It is considered below that the free movement is the movement obtained over a time step if the contact forces are not integrated.

The proposed system then uses a collision detection process that tests geometrically existing intersections between the objects 223, 230 in the scene and the preferential exit directions of the objects from the collision (FIGS. 6 and 7).

If an object 221 is considered which, in a position 223, comes to interact with another object 230, the preferential direction may be calculated only on the basis of geometrical criteria (FIG. 6) or may depend on the configuration whereby the objects 223, 230 came into collision, taking account of an intermediate movement 222 of at least one of the objects between the preceding calculation step and the current calculation step (FIG. 7).

In all cases the collision detection process extracts from pairs of elements of intersecting objects a length and a direction of interference between the two elements.

In the preferred situation of a description of the surface of the objects by triangles, an element is a point, a segment or the face of a triangle. Collision detection may then take into account three canonic cases of intersection between two objects: point/triangle intersection, segment/segment intersection, and triangle/point intersection.

The process may equally produce a set of object elements in proximity that could potentially collide following integration of the contact forces. A distance between these elements and its direction are then computed.

All the collision groups of the scene may be constructed using the description of all the interferences and proximities between the objects. Each group is then transferred into the contact module.

After the detection of a collision, processing in the contact module determines the configuration of the first contact between two computation time steps.

If account is taken of a description of the surface of the objects by triangles when an area of interpenetration between two objects has been defined at a time T of the simulation sampling step, a list of triangles constituting the pair of objects is extracted. If there are a rigid object and a deformable object, the coordinates of the triangle representing the deformable object are translated into the frame of reference of the rigid object at separate simulation sampling times T and T−1.

For all possible triangle/triangle pairs there is effected a linear interpolation of the displacement of three points D₁, D₂, D₃ of the deformable triangle between the initial and final positions at the discrete sampling times T and T−1. Three different types of test represented in FIGS. 3A to 3C may then be effected on the pair comprising a deformable triangle 20 defined by the vertices D₁, D₂, D₃ and having successive positions 21, 22, 23 between the times T−1 and T and a rigid triangle 30 defined by vertices R₁, R₂, R₃.

Test 1 (FIG. 3A) corresponds to the situation in which a collision plane is formed by the rigid triangle and establishes a constraint on the point concerned of the deformable triangle.

Test 2 (FIG. 3B) corresponds to the situation in which a collision plane is formed by a rigid segment and a deformable segment at the collision time t and establishes a constraint on two points of the deformable object.

Test 3 (FIG. 3C) corresponds to the situation in which a collision plane is formed by the deformable object at the collision time and establishes a constraint on three points of the deformable triangle.

The invention may be applied equally to collisions between a rigid object and a deformable object and to collisions between two deformable objects.

The contact module is described in more detail below with reference to a description of triangular objects.

The contact module is called as many times as there are collision groups in the scene at the computation time. The collision detection module has stored in a memory space for each collision:

the normal,

the pair of objects and the elements relevant to the collision, and

(where applicable) the points of application of the contact force.

If the collision detection algorithm does not give the points of application of the contact force (this is the situation of detection without intermediate movement shown in FIG. 6), they must be reconstructed and in all events these application points must be interpolated relative to the selected deformation module.

In the preferred case of a description of objects by triangles, the problem is split into two cases: there are either two segment elements or a node element and a face element.

In the case of a segment/segment intersection between a triangle 40 defined by vertices P₁, P₂, P₃ and a triangle 50 defined by vertices Q₁, Q₂, Q₃ (FIG. 4), the two selected points 41, 51 are situated at the intersection of each of the two segments Q₁, Q₂, respectively P₁, P₂ with the plane formed by the face of the other intersection triangle.

The vector connecting the two points 41, 51 found is denoted δ.

In the case of a point/face intersection between a triangle 60 defined by vertices P₁, P₂, P₃ and a triangle 70 defined by vertices Q₁, Q₂, Q₃ (FIG. 5), the first selected point is the point of the intersection and the second is the projection of that point onto the face of the intersection. The vector joining the two points found is denoted δ.

The intersection algorithm with intermediate movement proposed by Xavier Provot (Collision and self-collision handling in cloth model dedicated to design garments, Graphics Interface 1997, 177-189) may be used and produces an approximate configuration between the two triangles at the time of the collision.

Barycentric coordinates are used to distribute the displacements and forces at these points in the preferred case of linear interpolation for finite element modeling (triangles—tetrahedra).

To be able to compute the deformations of the objects correctly, non-interpenetration must be guaranteed. Interpolation of the elements is therefore used so as to have only one force and distance unknown per contact. To simplify the problem, linear interpolation is used for the finite elements.

Thus in the case of a segment/segment contact (FIG. 4):

$$δ = [ \begin{matrix}{a}_{i} & {b}_{i} & {c}_{i}\end{matrix} ] [ [ \begin{matrix}α & 1 - α\end{matrix} ] [ \begin{matrix}{W}_{1} \\ {W}_{2}\end{matrix} ] - [ \begin{matrix}β & 1 - β\end{matrix} ] [ \begin{matrix}{V}_{1} \\ {V}_{2}\end{matrix} ] ] \qquad ( 1 )$$

where:
α and 1−α are the barycentric coordinates of the first segment Q₁, Q₂ and β, 1−β those of the second segment P₁, P₂, aᵢ, bᵢ, cᵢ are the coordinates of the normal nᵢ of the triangle 40,
W₁, W₂ are the coordinates of the first segment Q₁, Q₂,
V₁, V₂ are the coordinates of the second segment P₁, P₂.

In the case of a point/plane contact (FIG. 5), aᵢ, bᵢ, cᵢ are the coordinates of the normal nᵢ of the triangle 60 and the interpenetration distance δ between the triangles 60 and 70 is written:

$$δ = [ \begin{matrix}{a}_{i} & {b}_{i} & {c}_{i}\end{matrix} ] [ [ \begin{matrix}α & β & γ\end{matrix} ] [ \begin{matrix}{W}_{1} \\ {W}_{2} \\ {W}_{3}\end{matrix} ] - {V}_{1} ] \qquad ( 2 )$$

where:
α, β, γ are the barycentric coordinates on the triangle 60 (sum=1),
W₁, W₂, W₃ are the coordinates of the first triangle 60, and
V₁ are the coordinates of the point of contact 71 consisting of a vertex Q₁ of the second triangle 70.

Exactly the same interpolation is used for the contact force.

Once the point of application of the contact forces has been found, the mechanical characteristics of the objects are transferred into the defined contact space. It is assumed below that a group of m contacts with n objects is processed.

To transport overall mechanical characteristics in the situation where the mass and inertia of the object are lumped together at its centre of mass, a conventional Jacobean matrix may be used, as defined in the works of Ruspini (Diego Ruspini & Oussama, “A Framework for Multi-Contact Multi-Body Dynamic Simulation and Haptic Display”, Proceedings of the 2000 IEEE/RSJ International Conference on Intelligent Robots and Systems). Using this matrix, there is an instantaneous relationship between the contact forces f_{c} in the contact direction and the accelerations δ″_{c} (constrained) and δ″_{free} in the same direction:
δ″_{c}=J_{c}M⁻¹J_{c}^{T}f_{c}+δ″_{free} (3)
where:
J_{c} is an m*6n Jacobean matrix that transfers the instantaneous linear and angular movement into the contact space,
M is a block diagonal matrix corresponding to the mass and inertia of the n objects of the group of contacts, and J_{c}^{T} is the transposed matrix of J_{c}.

The interpolation defined for the triangles may be used to transport the local characteristics. There is therefore a relationship between the displacements of the points of the deformable mesh and the displacements in space of the contacts, and the same interpolation may be used between the contact forces and the forces at the nodes.

Returning to the linear instantaneous relationship characterizing the deformations:
δ_{c}=[Σᵢ₌₁ⁿN_{c}ⁱA(Uₖ₋₁) (N_{c}ⁱ)^{T}]f_{c}+δ_{free} (6)
where N_{c}ⁱ represents the matrix for passing from the displacement space of the mesh to the displacement space at the contact points and A is a matrix as defined above.

The contact modeling process selected obeys the laws of physics as much as possible. By way of simplification, it is nevertheless preferable to consider that the contact directions will not change during the solution of the computation even if this is not strictly the case in practice.

The first postulate of the Signorini problem is that there is no interference between the objects if they are solid (their materials do no mix). Thus after the solution of the problem a positive or zero displacement is required at the contact point:
δ_{c}≧0 (9)

The second postulate is that the situation is one of contact without friction, so that the contact force is directed along the normal:
f_{c}≧0 (10)

The third postulate is that the contact force is non-zero (f_{c}±0) if and only if there is really contact (δ_{c}=0). This produces a complementary relationship between the two vectors:
δ_{c}⊥f_{c} (11)

The transport of the mechanical characteristics is used to make it possible to solve the Signorini problem. The effects of the local and overall characteristics are summed by integrating the accelerations to yield exclusively a relationship between displacement and force in the contact space.

In order to integrate the accelerations, it is advantageous to use a numerical method that tends to ensure conservation of energy, like the trapezium method (also known as the Tustin method), and this may be expressed in the following form if a magnitude X is considered at times t(Xₜ) and t+1(Xₜ₊₁)
Xₜ₊₁=Xₜ+½dt(Xₜ′+Xₜ₊₁′)
Xₜ₊₁′=Xₜ′+½dt(Xₜ″+Xₜ₊₁″) (12)

Using the above numerical method and equations (4) and (5), the following relationship is obtained:
δ_{c}=[¼dt²J_{c}M⁻¹J_{c}^{T}+Σᵢ₌₁ⁿN_{c}ⁱCⁱ(Uₖ₋₁)(N_{c}ⁱ)^{T}]f_{c}+δ_{free} (13)
The coefficient ¼ may be different if a different method of integrating the accelerations is used.

If the mechanical model selected has no overall characteristics and if the mass and inertia are integrated in the deformation model at the local level, only equation (5) is used, which already implicitly includes numerical integration over time.
δ_{c}=[Σᵢ₌₁ⁿN_{c}ⁱA(Uₖ₋₁) (N_{c}ⁱ)^{T}]f_{c}+δ_{free} (6)

The postulates defined in the Signorini problem and the instantaneous linear equation creating a linear relationship between contact forces and displacements in the contact space mean that the contacts may be formulated in linear complementarity problem (LCP) form. There are numerous algorithms for solving this type of problem (see for example Murty, K. G., Linear Complementarity, Linear and Nonlinear Programming, Internet Edition (1997)) that are able to solve the problem in a time compatible with the performance required by haptics. For example, a computation may be performed at a frequency of the order of 500 Hz to 1000 Hz for a reasonable number of contacts (for example 30 to 40 contacts) using the main Pivot algorithm on a 2 GHz Pentium IV type PC.

FIG. 3 shows the interaction between a deformable object 80, such as forceps, and another object 90. In this case, the deformable object 80 is virtually attached to the haptic interface (as soon as it is held by the user) in an area of a node O defining a frame of reference Ox₀y₀z₀. Dirichlet conditions may be applied to such points.

In each simulation step, the free movement configuration yields a contact space. An LCP solution gives the non-zero contact forces fᵢ and a constrained movement is deduced therefrom. These forces (illustrated by the normal Uᵢ with coordinates aᵢ, bᵢ, cᵢ in FIG. 9) are transported to the point O to create the force and the torque at the haptic interface.

FIGS. 10A to 10C show the example of a deformable object 80 consisting of a clip fitted to a tube 91. Different deformations of the clip 80 are seen at different positions 81, 82, 83 relative to the tube 91.

1. A method of interactively simulating contact between a deformable first object and a second object using a simulated model with a predetermined sampling time step, the method being characterized in that:
(a) the parameters describing the physical characteristics of each of the objects, such as the geometry and the mechanics of the materials of each of the objects, are calculated beforehand and stored in a memory,
(b) at the beginning of each sampling time step of the simulated model, a real-time analysis of the inherent behavior of each object is carried out at the level of each object in order to predict the positions, speeds and accelerations of that object in application of a free movement that does not take account of any subsequent contacts,
(c) in each sampling time step of the simulated model, pairs of objects that are detected as intersecting are analyzed in real time at the level of an overall scene including the objects liable to come into contact, and a list of groups of collisions is established that contains a string of objects in collision and a description of the collisions,
(d) in each sampling time step of the simulated model, parameters representing the physical characteristics of the objects and the description of the collisions are repatriated in real time for each group of collisions to determine, for each instance, the solution to the Signorini problem that governs contact between two objects in the case of pure relative sliding,
(e) at the end of each sampling time step of the simulated model, a real-time display of the inherent behavior of the object following the collision is effected at the level of each object, and
(f) all real-time processing is effected with a computation time step shorter than the sampling time step of the simulated model so as to define an interactive simulation in which the user can intervene directly during simulation.

2. A method according to claim 1, characterized in that during the step a) of calculating beforehand parameters describing the physical characteristics of each of the objects, a finite element type description of deformations is used for the parameters describing the mechanics of the materials, with matrices being filled and inverted, systems of equations being solved, and data being stored in memory.

3. A method according to claim 1, characterized in that each object is described in a rest configuration as a set of triangles reproducing its surface and a set of tetrahedra describing the interior of the object.

4. A method according to claim 3, characterized in that each triangle is described by three points placed in an order such that normals are calculated that are invariably directed towards the exterior of the object.

5. A method according to claim 3, characterized in that the deformations of the objects are interpolated by the finite element method using a linear tetrahedral mesh.

6. A method according to claim 1, characterized in that in each computation time step the explicit forces applied to an object, which are already known at the start of the computation step, are integrated during the step b) at object level to define the movements of the object that they generate, whereas the values of the implicit contact forces, which depend on the movement of the objects in the computation time step, are determined during the step d) of seeking the solution to the Signorini problem at the level of an overall scene.

7. A method according to claim 1, characterized in that during the step c) of analysis at the level of an overall scene, the existing intersections between the objects of the scene are detected geometrically in order to extract from pairs of elements of intersecting objects a length and a direction of interpenetration between the two elements of a pair of elements of objects.

8. A method according to claim 7, characterized in that during the step c) of analysis at the level of an overall scene, to extract from pairs of elements of intersecting objects a length and a direction of interpenetration between the two elements of a pair of elements of objects, an intermediate movement of the objects between the preceding computation step and the current computation step is also taken into account in order to compute a preferential direction of interference between the objects.

9. A method according to any one of claim 24, characterized in that during the step d) of seeking the solution to the Signorini problem, the extreme points of application of the contact force between the two objects in collision are reconstructed if those extreme application points have not been determined during the preceding step.

10. A method according to claim 9, characterized in that during the step d) of seeking the solution to the Signorini problem, in the case of a segment-segment intersection of two triangular objects, the two points selected to constitute the extreme points of application of the contact force between the two objects in collision are situated at the intersection of each of the two segments (P₁P₂, Q₁Q₂) with the plane formed by the face of the triangle in the intersection.

11. A method according to claim 9, characterized in that during the step d) of seeking the solution to the Signorini algorithm, in the case of a point-face intersection of two triangular objects, a first point selected to constitute a extreme point of application of the contact force between the two objects in collision is the point of the intersection whereas the second extreme point of application of the contact force between the two objects in collision is the projection of the first extreme point onto the face of the triangle in the intersection.

12. A method according to claim 9, characterized in that barycentric coordinates are used to distribute the displacements and the forces of the points of application of the contact force between the extreme points of application of the contact force by effecting a linear interpolation for a finite element modeling process.

13. A method according to claim 25, characterized in that the distance δ of interpenetration between the two extreme points of application of the contact force in the case of a segment-segment contact between a first segment (Q₁ Q₂) and a second segment (P₁ P₂) of a second triangle is calculated from the following equation:
$$δ = [ \begin{matrix}{a}_{i} & {b}_{i} & {c}_{i}\end{matrix} ] [ [ \begin{matrix}α & 1 - α\end{matrix} ] [ \begin{matrix}{W}_{1} \\ {W}_{2}\end{matrix} ] - [ \begin{matrix}β & 1 - β\end{matrix} ] [ \begin{matrix}{V}_{1} \\ {V}_{2}\end{matrix} ] ] \qquad ( 1 )$$
in which:
α and 1−α are the barycentric coordinates on the first segment (Q₁ Q₂)
β and 1−β are the barycentric coordinates on the second segment (P₁ P₂),
aᵢ bᵢ cᵢ are the coordinates of the interpenetration direction nᵢ,
W₁ and W₂ are the coordinates of the first segment Q₁ Q₂, and
V₁ and V₂ are the coordinates of the second segment P₁ P₂.

14. A method according to claim 26, characterized in that the distance δ of interpenetration between the two extreme points of application of the contact force in the case of a point-plane contact between a point of a second triangle and a plane (P₁ P₂ P₃) of a first triangle is calculated from the following equation:
$$δ = [ \begin{matrix}{a}_{i} & {b}_{i} & {c}_{i}\end{matrix} ] [ [ \begin{matrix}α & β & γ\end{matrix} ] [ \begin{matrix}{W}_{1} \\ {W}_{2} \\ {W}_{3}\end{matrix} ] - {V}_{1} ] \qquad ( 2 )$$
in which:
α, β and γ are the barycentric coordinates on the first triangle,
aᵢ bᵢ cᵢ are the coordinates of the interpenetration direction nᵢ,
W₁, W₂, W₃ are the coordinates of the first triangle (P₁ P₂ P₃),
V₁ represents the coordinates of the point of contact consisting of a vertex (Q₁) of the second triangle (Q₁ Q₂ Q₃).

15. A method according to claim 1, characterized in that when the points of application of the contact forces between two objects in collision have been determined, during the step d) the mechanical characteristics of the objects are transferred into the defined contact space in which the whole of a group of m contacts with n objects is processed, where m and n are integers.

16. A method according to claim 15, characterized in that during the step d) the mass and inertia of an object are considered lumped together at its centre of mass and an instantaneous relationship between the contact forces f_{c} in the contact direction, the accelerations δ″_{c} caused by the constraints in the same direction, and the free accelerations δ″_{free} in the same direction known during the step c) at the level of an overall scene is established from the equation:
δ″_{c}=J_{c}M⁻¹J_{c}^{T}f_{c}+δ″_{free} (3)
in which:
J_{c} is an m*6n Jacobean matrix that transfers the instantaneous linear and angular movement into the contact space,
J_{c}^{T} is the transposed matrix of J_{c},
M is a block diagonal matrix corresponding to the mass and inertia of the n objects of the group of contacts.

17. A method according to claim 27, characterized in that during the step d), to transport the local mechanical characteristics, a relationship is established between:
the displacement difference (Uₖⁱ) of the points of the deformable mesh representing the object i at the time k, between the free deformation (Uⁱ_{k.free}) and the constrained deformation (Uⁱ_{k,c}), in other words Uₖⁱ=Uⁱ_{k,c}−Uⁱ_{k,free}
the free and constrained relative positions δ_{free} and δ_{c} of the objects in the contact space:
δ=Σ_{I=1}ⁿN_{c}ⁱUₖⁱ+δ_{free} (4)
where N_{c}ⁱ is a matrix for passing from the displacement space of the mesh to the displacement space of the contacts, and
a relationship is established between the forces in the contact space f_{c} and the forces in the deformation forces space Fₖ:
Fₖ=(N_{c}ⁱ)^{T}f_{c} (5)

18. A method according to claim 1, characterized in that during the step d) an instantaneous linear relationship characterizing contact deformations or displacements δ_{c} from the contact forces f_{c} and the free displacements δ″_{free} caused by free movements integrating only the forces known explicitly at the beginning of the computation time step is established from the following equation:
δ_{c}=[Σᵢ₌₁ⁿN_{c}ⁱA(Uₖ₋₁) (N_{c}ⁱ)^{T}]f_{c}+δ_{free} (6)
in which:
Nⁱ_{c} is a matrix for passing from the displacement space of the mesh to the displacement space of the contacts,
(Nⁱ_{c})^{T} is the transposed matrix of Nⁱ_{c}.
A is a matrix defining the deformation of the object at the local level, such that if Uₖ represents the vector of the displacement in the local frame of reference of the object at the current time and Uₖ₋₁, represents the displacement vector in the local frame of reference of the object in the preceding calculation step, the instantaneous values whereof are known at the beginning of the current computation step, then:
U_{K}=A(Uₖ₋₁)Fₖ+b(Uₖ₋₁) (7)
where:
Fₖ is a vector representing the external forces applied to the object expressed in the local frame of reference, and
b is a vector that has a value in the displacement space and depends on the object deformation model.

19. A method according to claim 17, characterized in that during the step d) an instantaneous relationship characterizing the contact deformations or displacements δ_{c} from the contact forces f_{c} and the free displacements δ″_{free} caused by free movements integrating only the forces known explicitly at the beginning of the computation time step is established from the following equation:
δ_{c}=[θdt²J_{c}M⁻¹J_{c}^{T} +Σᵢ₌₁ⁿN_{c}A(ₖ₋₁) (N_{c}ⁱ)^{T}]f_{c}+δ_{free} (8)
in which:
J_{c} is an m*6n Jacobean matrix that transfers the instantaneous linear and angular movement into the contact space,
J_{c}^{T} is the transposed matrix of J_{c},
M is a block diagonal matrix corresponding to the mass and inertia of the n objects of the group of contacts,
θ is a constant depending on the time integration method,
Nⁱ_{c} is a matrix for passing from the displacement space of the mesh to the displacement space of the contacts,
(Nⁱ_{c})^{T} is the transposed matrix of Nⁱ_{c},
A is a matrix defining the deformation of the object at the local level such that if Uₖ represents the vector of the displacement in the local frame of reference of the object at the current time and Uₖ₋₁ represents the displacement vector in the local frame of reference of the object in the preceding calculation step the instantaneous values whereof are known at the beginning of the current computation step, then:
U_{K}=A(Uₖ₋₁)Fₖ+b(Uₖ₋₁) (7)
where:
Fₖ is a vector representing the external forces applied to the object expressed in the local frame of reference, and
b is a vector that has a value in the displacement space and depends on the object deformation model.

20. A method according to claim 1, characterized in that it further comprises a step of coupling with a haptic interface module to produce haptic sensation feedback to a mechanical system by means of which an operator manipulates the objects in a virtual scene.

21. A system for the interactively simulating contact between a deformable first object and a second object using a simulated model with a predetermined sampling time step, the system being characterized in that it comprises:
(a) a module for calculating beforehand parameters describing the physical characteristics of each of the objects, such as the geometry and the mechanics of the materials of each of the objects,
(b) a memory for storing parameters previously calculated in the computation module,
(c) a coupling module to a user interface comprising a mechanical system held by a user to exert virtual forces on said objects in a scene of the simulated model,
(d) a display screen for displaying said objects represented in the form of meshes,
(e) a central processor unit associated with input means, comprising at least:
e1) an object analysis module for analyzing in real time at the level of each object the inherent behavior of the object in order to predict the positions, speeds and accelerations of that object in application of a free movement that does not take account of any subsequent contacts,
e2) an analysis module for an overall scene including the objects liable to come into contact, for analyzing in real time pairs of objects that are detected to be interacting and to establish a list of groups of collisions that contains a string of objects in collision and a description of the collisions,
e3) a module for the real time repatriation, for each group of collisions, of the parameters representing the physical characteristics of the objects and the description of the collisions, for determining, for each instance, the solution to the Signorini problem that governs contact between two objects in the case of pure relative sliding,
e4) a module for processing each object for real time display at the level of each object of the inherent behavior of that object following a collision, and
e5) means for determining a computation step shorter than the sampling time step of the simulated model so as to define an interactive simulation.

22. A system according to claim 21, characterized in that it comprises means for producing haptic sensation feedback to the user interface.

23. A system according to claim 21, characterized in that the computation step corresponds to a frequency greater than or equal to approximately 500 Hz.

24. A method according to claim 3, characterized in that during the step c) of analysis at the level of an overall scene, the existing intersections between the objects of the scene are detected geometrically in order to extract from pairs of elements of intersecting objects a length and a direction of interpenetration between the two elements of a pair of elements of objects.

25. A method according to claim 10, characterized in that barycentric coordinates are used to distribute the displacements and the forces of the points of application of the contact force between the extreme points of application of the contact force by effecting a linear interpolation for a finite element modeling process.

26. A method according to claim 11, characterized in that barycentric coordinates are used to distribute the displacements and the forces of the points of application of the contact force between the extreme points of application of the contact force by effecting a linear interpolation for a finite element modeling process.

27. A method according to claim 9, characterized in that when the points of application of the contact forces between two objects in collision have been determined, during the step d) the mechanical characteristics of the objects are transferred into the defined contact space in which the whole of a group of m contacts with n objects is processed, where m and n are integers.
